(19) United States
(12) Patent Application Publication
(10) Pub. No.: US 2009/0273670 A1
(43) Pub. Date: Nov. 5, 2009

(54) Door cam security

(76) Inventor: Christina Tamayo, Phoenix, AZ (US)

Correspondence Address: RUTH EURE, 4795 EDISON AVENUE, BOULDER, CO, 80301, US

(21) Appl. No.: 12/386,306

(22) Filed: Apr. 16, 2009

Related U.S. Application Data
(60) Provisional application No. 61/124,403, filed on Apr. 16, 2008.

(51) Int. Cl. H04N 7/18; G06F 7/04

(52) U.S. Cl. 348/143; 340/5.7; 348/E07.085

(57) ABSTRACT

A remote viewing system is disclosed for providing video surveillance of an entry or doorway of a building. A video camera is positioned to obtain video images of the entryway or doorway and to transmit them to a remote viewing station. Video data can be transmitted from the driver to any of a variety of electronic devices, including PCs, PDAs, cell phones, and the like. The video information can also be stored for future reference.

### CLAIM OF PRIORITY

This patent application claims priority from U.S. Provisional patent application Ser. No. 61/124,403, filed Apr. 16, 2008, entitled “Door Cam Security” of common inventorship herewith.

### FIELD OF THE INVENTION

This invention pertains to the field of security systems and more specifically to the field of residential security.

### BACKGROUND OF THE INVENTION

Several inventions have been put forth by the prior art addressing the issue of residential door security systems.

U.S. Patent Application Publication 20060156361 to Wang addresses a remote viewing system providing video and/or audio surveillance of an entry or doorway of a building.

U.S. Pat. No. 5,635,981 to Ribacoff describes a visitor identification system.

U.S. Pat. No. 7,015,943 to Chiang describes a premises entry security system having a removable flash memory device.

None of these prior art references describe the present invention.

### SUMMARY OF THE INVENTION

It is an object of the present invention to provide a door cam security system which provides a permanent digital record of anyone who steps on the door mat.

### BRIEF DESCRIPTION OF THE DRAWINGS

FIG. 1 is a view of the camera box of the present invention with the door closed.

FIG. 2 is a view of the camera box of the present invention with the door open for viewing the visitor.

FIG. 3 is a view of a visitor at the door activating the door mat sensor of the present invention.

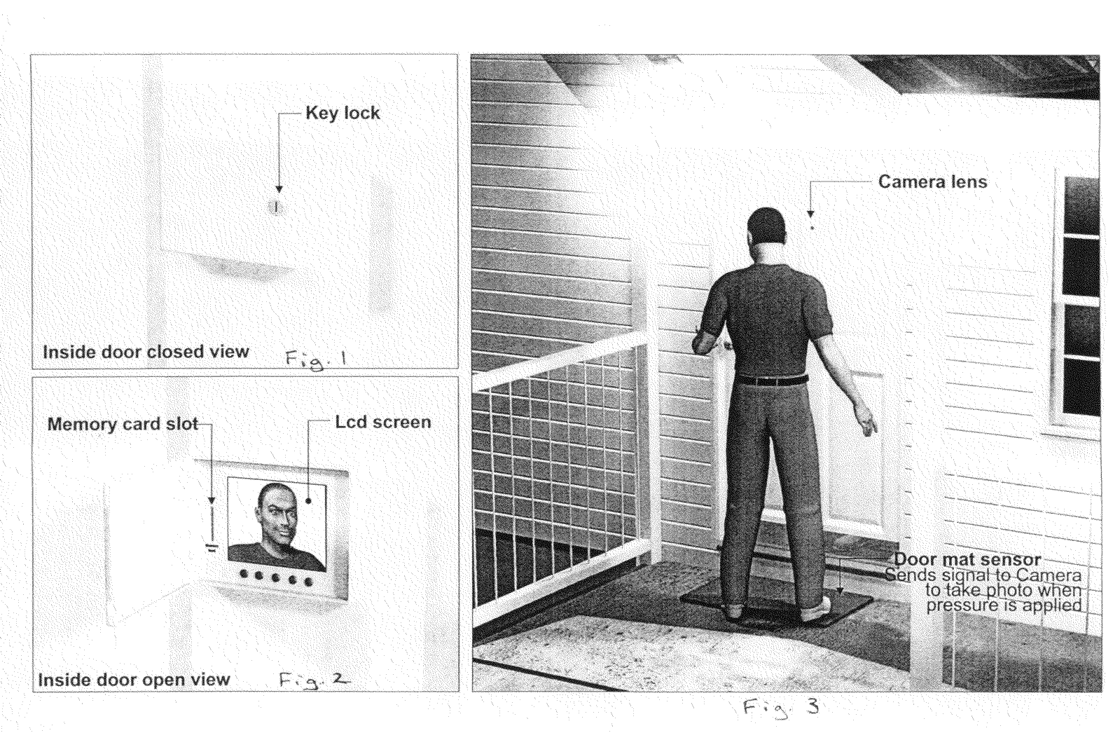

### DETAILED DESCRIPTION OF THE INVENTION

One of the more frightening and potentially dangerous crimes that can occur to an individual or family is a home invasion. A home invasion is when one or more criminals force their way into an occupied home or apartment to commit a robbery or other crimes. It is particularly frightening because it violates our private space and the one place that we think of as our sanctuary. Home invasion perpetrators, unlike burglars, work more often at night and on weekends when homes are more likely to be occupied. The home invader will sometimes target the resident as well as the dwelling. Home invaders rely on an overwhelming physical confrontation to gain initial control and instill fear in you. The greatest violence usually occurs during the initial sixty seconds of the confrontation and home invaders often come prepared with handcuffs, rope, duct tape, and firearms. The act of committing a home invasion is escalating much like car jacking. The reason for the increase seems to follow a similar pattern. Much like automobiles, the traditional commercial targets for robbers like convenience stores and fast-food restaurants have hardened themselves against criminal attack and have reduced available cash.

Technology has allowed commercial establishments to install affordable video surveillance systems, silent alarms, and other anti-crime deterrent devices. A residence, by comparison, is now a more attractive choice. Home invaders know that they won't have to overcome alarm systems when the home is occupied or be worried about video cameras and silent alarms. Unlike robbing a retail store, home invaders expect privacy once inside your home and won't have to deal with the police suddenly driving up or customers walking in. Once the offenders take control of a residence they can force the occupants to open safes, locate hidden valuables, supply keys to the family car, and PIN numbers to their ATM cards. They can also perform more heinous crimes such as raping an occupant. The most common point of attack is through the front door or garage. Home invaders will sometimes use a ruse or impersonation to get you to open the door. More common is when the home invaders simply knock on the door first or ring the bell. The home invader hopes that the occupant will simply open the door, without question, in response to their knock. Unfortunately, many people do just that. To provide consumers an affordable, camera based security system which would allow them to view an individual before opening the door to allow entry, the present invention was developed and is hereinafter referred to as “Door Cam Security”.

A remote viewing system is disclosed for providing video surveillance of an entry or doorway of a building. A video camera is positioned to obtain video images of the entryway or doorway and to transmit them to a remote viewing station. Video data can be transmitted from the driver to any of a variety of electronic devices, including PCs, PDAs, cell phones, and the like.

The Door Cam Security is comprised of a digital camera, a camera enclosure, a doorbell and a welcome mat. The camera enclosure is an essentially rectangular box with a hinged back panel which is used to access the camera. The camera enclosure is mounted on the interior side of a front door and the camera is securely positioned within the box. The camera is positioned with the lens directly behind the ‘peep hole’ on the door, making it possible to take a picture of an individual on the outside who rang the door bell or knocked on the door. The door bell and the welcome mat are equipped with wireless transmitters which activate the camera whenever someone rings the doorbell or steps on the mat. Before opening the door, the occupant could open the back panel on the camera and view the picture on the liquid crystal display screen on the rear side of the camera to ensure the individual was ‘legitimate’ and protect themselves and their family. Alternatively, the occupant can view the image of the visitor on a remote viewing station, such as a computer, cell phone or other remote viewing device.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A security system for providing video data to a remote location, the system comprising:
a door having a peep hole;
a camera disposed near the peep hole of the door, the camera positioned to obtain video data from a location adjacent to the door;
processing circuitry associated with the camera for processing video data from the camera and transmitting the processed video data to a remote viewing location;
a video monitor located at the remote viewing location for receiving the processed video data and displaying the video data obtained from the camera, and
a computer associated with the video monitor, the computer being configured to make the video data available to a user, and the computer further being configured to store the video data.

2. The system of claim 1, further comprising a power supply associated with the camera and processing circuitry, wherein the power supply is a battery and is disposed within the front and back panels of the door.

3. The system of claim 1, further comprising a memory element associated with the processing circuitry, the memory element being capable of storing the processed video data.

4. The system of claim 3, wherein the camera is activated by a signal provided by a pressure sensor disposed mounted in a door mat.
